(19) United States
(12) Patent Application Publication
(10) Pub. No.: US 2014/0325672 A1
(43) Pub. Date: Oct. 30, 2014

(54) METHOD OF PROVIDING LAWFUL INTERCEPTION OF DATA IN A SECURE COMMUNICATION SYSTEM

(71) Applicant: Cellcrypt Group Limited, Ugland house (KY)

(72) Inventor: Paul Anthony GALWAS, St. Ives (GB)

(73) Assignee: Cellcrypt Group Limited, Ugland house (KY)

(21) Appl. No.: 13/957,567

(22) Filed: Aug. 2, 2013

Related U.S. Application Data
(63) Continuation of application No. PCT/US2012/023654, filed on Feb. 2, 2012.
(60) Provisional application No. 61/438,722, filed on Feb. 2, 2011.

(51) Int. Cl. H04W 12/02

(52) U.S. Cl. CPC H04W 12/02
USPC 726/27

(57) ABSTRACT

A communication system including one or more end points, each end point interconnected to a wireless network. The communication system also includes a media network system, the network system contains a registration server for registering device IDs of the end points in the communication system, a database for storing device IDs, one or more media servers for routing calls between end points and a signaling server for selecting one or more media servers to route a call between end points in the communication system based on an algorithm that evaluates one or more predetermined conditions.

### FIELD OF THE INVENTION

The present disclosure relates to providing voice and other real-time communications of digital data over networks. In particular, the present disclosure relates to providing lawful interception of data in a secure communication system.

### BACKGROUND OF THE INVENTION

Many states require telephony service operators to provide lawful interception, which is obtaining communications network data pursuant to lawful authority for the purpose of analysis or evidence. Such data generally consist of signaling information and/or content of the communications. If the data is not obtained in real-time, the activity is referred to as access to retained data (RD).

Signaling data typically provides call records that identify, for example, the calling parties, time and duration of a call, and/or a make record of the audio on the call.

Increasingly, telephony calls are encrypted end to end to keep the call confidential from those who have access to the network over which the call passes. Effective end to end encryption prevents lawful interception. Hence, there is a need for a mechanism to provide lawful interception of end to end encrypted calls/data.

The present disclosure is directed toward, but not limited to, providing a mechanism for one or more agents, such as, for example, telephone operators, to enable lawful interception and retain data for end to end encrypted calls and other messages.

### SUMMARY OF THE INVENTION

Exemplary embodiments disclosed herein provide a method of providing lawful interception of data in a secure communication system. The method, for example, includes associating a lawful intercept unit with each agent in the communication system, assigning one or more end points to each agent in the system, assigning one or more agent rights for each agent, storing information corresponding to the assigned one or more end points and interception rights for each agent, and providing data from a lawful interception unit to a corresponding agent consistent with the one or more interception rights of the corresponding agent.

Exemplary embodiments disclosed herein provide a communication system for providing lawful interception of end to end encrypted data. The system includes, one or more end points for communicating over a network, one or more agents, each having access rights relating to intercepting data of the one or more end points, one or more media servers for receiving data from an end point and using media protocols to send the data across the network, one or more signaling servers for dynamically selecting one or more media servers on a per call basis to route data between two of the one or more end points in the system, and a plurality of lawful intercept units, each unit is associated with an agent and is interfaced to one of the one or more media servers.

### BRIEF DESCRIPTION OF THE DRAWINGS

FIG. 1 is a block diagram illustrating an exemplary embodiment of a communication system as disclosed herein.

FIGS. 2A and 2B are block diagrams illustrating exemplary embodiments of an agent rights database and an end point database.

FIG. 3 is a block diagram illustrating an exemplary embodiment of a centralized agent right database.

FIG. 4 is a flow chart illustrating an exemplary representation of call setup and call routing.

FIG. 5 is a flow chart illustrating an exemplary representation of lawful interception of data.

### DETAILED DESCRIPTION

The present disclosure describes the lawful interception of data in a communication system. The system includes one or more agents which intercept data from one or more end points. Each agent is associated with a lawful intercept unit which provides recorded call data and real time call traffic.

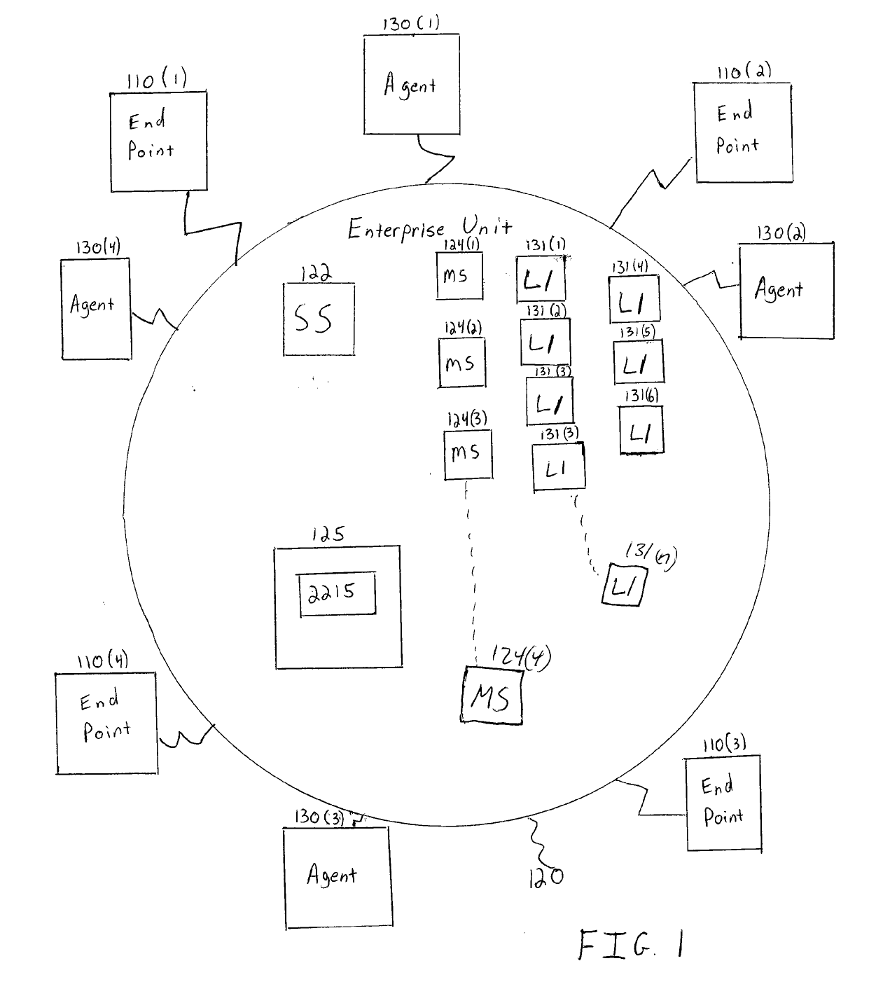

FIG. 1 is a diagram illustrating an exemplary embodiment of a communication system. The system includes end points 110, agents 130 and enterprise unit 120. The end points and agents communicate wirelessly with enterprise unit 120. The end points and agents communicate with one another via enterprise unit 120. Enterprise unit includes a network system (not shown) for effectuating communication between devices in the communication system.

End point 110 can be, for example, a mobile end point, which includes mobile equipment (e.g., mobile phone) equipped with encryption modules. The encryption modules provide encryption and decryption functions for voice data in real time and establish a secure communication link with another end point in the communication system. The encryption modules can be processors embedded with computer readable instructions that when executed perform encryption and decryption functions.

In addition, end point 110 can be, for example, a gateway device. A gateway device connects a traditional phone system, such as, for example, Public Switched Telephone Network (PSTN) and Private Branch Exchange (PBX) to enterprise unit 120. The gateway converts the PSTN or PBX telephone traffic into an IP format for transmission over an IP network.

The gateway is equipped with an encryption module to facilitate encryption and decryption functions. Transparent point-to-point encryption is provided between end points. The encryption modules may use redundant encryption schemes for session, authentication, digesting and/or key exchange. Preferred embodiments use two strong algorithms at the same time in series.

End point 110 includes a database manager and a storage device for storing one or more databases.

Agent 130 includes one or more microprocessors, computer readable memory (e.g., read-only memory (ROM) and random access memory (RAM)), mechanisms and structures for performing I/O operations. Each agent includes application programs and/or computer readable instructions for controlling the operation of the one or more microprocessors, a database manager and a storage device for storing one or more databases.

An agent 130 is associated with a user (i.e. agent-user) that is authorized to intercept calls/data from end points associated with the agent. An agent-user can be, for example, the user of an end point, the employer of the user of the end point, the owner of the end point, the operator from whom the user contracts to buy encrypted real-time service using an end point, the operator that grants the end point access to the service, which may be different from the operator with whom the user contracts, such as when the user is roaming, the owner or operator of a system component, such as a signaling server or media server, or other network component and the state that governs the geographic location from which, or through which, the end point is making a call.

Each agent 130 is associated with a lawful intercept unit (LI) 131 which provides recorded call data and real time call traffic to the agent-user via the agent. An agent 130 is identified by a unique agent ID and has an asymmetric key pair including a public key and private key, which are used to keep the agent's LI data confidential. An end point 110 is associated with zero or more agents and an agent 130 is associated with one or more end points.

Lawful intercept unit (LI) 131 includes one or more microprocessors, computer readable memory (e.g., read-only memory (ROM) and random access memory (RAM)), mechanisms and structures for performing I/O operations. Each LI includes application programs and/or computer readable instructions for controlling the operation of the one or more microprocessors. LI131 includes a database manager and a storage device for storing one or more databases, such as, for example, intercepted data database. The storage device can be implemented with a variety of components or subsystems including, for example, a magnetic disk drive, an optical drive, flash memory, or any other devices capable of persistently storing information.

Each agent has zero or more agent rights which control an agent's ability to intercept data. The rights may include, for example, right to access a call record, right to access recorded data (RD), such as a recording of a call in one direction or both directions, right to access the full voice communication of a call in real time in one direction or both directions. A right may apply to all the end points associated with an agent, to a particular type of agent, or to specific end points. When a right applies to specific end points, each right is associated with an end point set, so that the associated right applies only when an end point in the end point set is part of a call. Each end point in the end point set is identified by its Device ID. An end point set is identified, for example, as follows:

End point set<n>={DeviceID(1),DeviceID(2) . . . }

Enterprise Unit 120 includes a network system, such as, for example, an Internet Protocol (IP) system. The enterprise unit includes one or more signaling servers 122, one or more media servers 124, and one or more LI 131. The signaling servers and media servers include one or more microprocessors, computer readable memory (e.g., read-only memory (ROM) and random access memory (RAM)), mechanisms and structures for performing I/O operations. The signaling servers and media servers each include a database manager and a storage device for storing one or more databases. The signaling server sets up the call, and the media server uses media protocols for receiving voice data and sending it across the network.

The enterprise unit also includes storage device 125 and a database manager. The storage device can be implemented with a variety of components or subsystems including, for example, a magnetic disk drive, an optical drive, flash memory, or any other devices capable of persistently storing information. Storage device 125 includes one or more databases, such as, for example, centralized device database 2215.

The database manager includes one or more microprocessors, computer readable memory (e.g., read-only memory (ROM) and random access memory (RAM)), mechanisms and structures for performing I/O operations. Database manager can execute an operating system for command execution on the one or more microprocessors and an application program for controlling the operations of the centralized database 2215. The application program can be developed using any suitable computer programming language, such as, for example, Java programming.

Signaling server 122 receives a request from an end point to make a call to another end point. The signaling server sets up the call, telling each end point to contact a media server (e.g., 124 (1), 124 (2), 124 (3)), which may be different. Each LI 131 is connected to a media server. A media server 124 can connect to multiple LIs. Call recordings and real time call traffic are provided to an authorized agent from a signaling server. Each signaling server includes an agent rights database and an end point database.

Zero or more agents may have access rights to call records for a call and/or to recorded data of a call and/or get real time call data that involves an end point over which it has rights. To achieve this, the agent 130 must be known to the signaling server 122 to which the end point 110 can establish its calls. A signaling server can be associated with zero or more agents and the agent's rights. The end points over which the agent has rights as specified in an end point set must be registered with the signaling server.

The agent 130 set up process establishes this relationship as follows:

1. The agent 130 delivers to the signaling server 122:
a. Agent ID and agent type
b. Public keys
c. List of all media servers (identified by their media server ID) to which the agent has a LI connected
d. agent rights
e. Optionally, a digital certificate, signed by a certificate authority that demonstrates authenticity of origin of the data and provides non repudiation

When the signaling server 122 receives this data, if a certificate is used, the signaling server verifies the certificate to confirm the identity of the agent and exist with an error if verification fails, and thereafter, the signaling server stores an agent record in the agent rights database, as illustrated in FIG. 2A. Each agent record includes Agent ID, agent type, public key, media server IDs, agent rights and optionally a digital certificate.

The signaling server 122 processes the associated agent rights. The signaling server may receive the agent rights of an agent from the agent or separately from another authorized body. When the signaling server receives the agent rights, it stores the rights in the agent record in the database. The agent 130 and other entities periodically send updated information to the signaling server, which modifies the associated agent record in its database accordingly.

When an end point 110 is provisioned to use a signaling server 122, the provisioner (e.g., an agent 130) sends to the signaling server the Device ID of the end point and a list of all agent IDs with which the end point is associated. The signaling server stores a corresponding end point record in an end point database, as illustrated in FIG. 2B

The DeviceID identifies the end point 110 to the signaling server 122 and the Agent ID identifies an agent 130 associated with the end point.

The information in the agent rights database and end point database is updated periodically. An agent 130 delivers to the signaling server 122 a list of DeviceIDs that are newly associated with the agent and the information is registered with the signaling server. In addition, the agent delivers to the signaling server a list of DeviceIDs that are no longer associated with the agent.

Optionally, a digital certificate signed by a private key that demonstrates authenticity of origin of the data and non repudiation is used. The signaling server 122 verifies the certificate using the public key associated with the Agent ID and an error occurs if verification fails.

The signaling server 122 changes the end point record that is associated with the DeviceID and Agent ID (associated with the public key used to verify the certificate) in the end point database to add the new DeviceIDs to the record and removes those that are no longer associated.

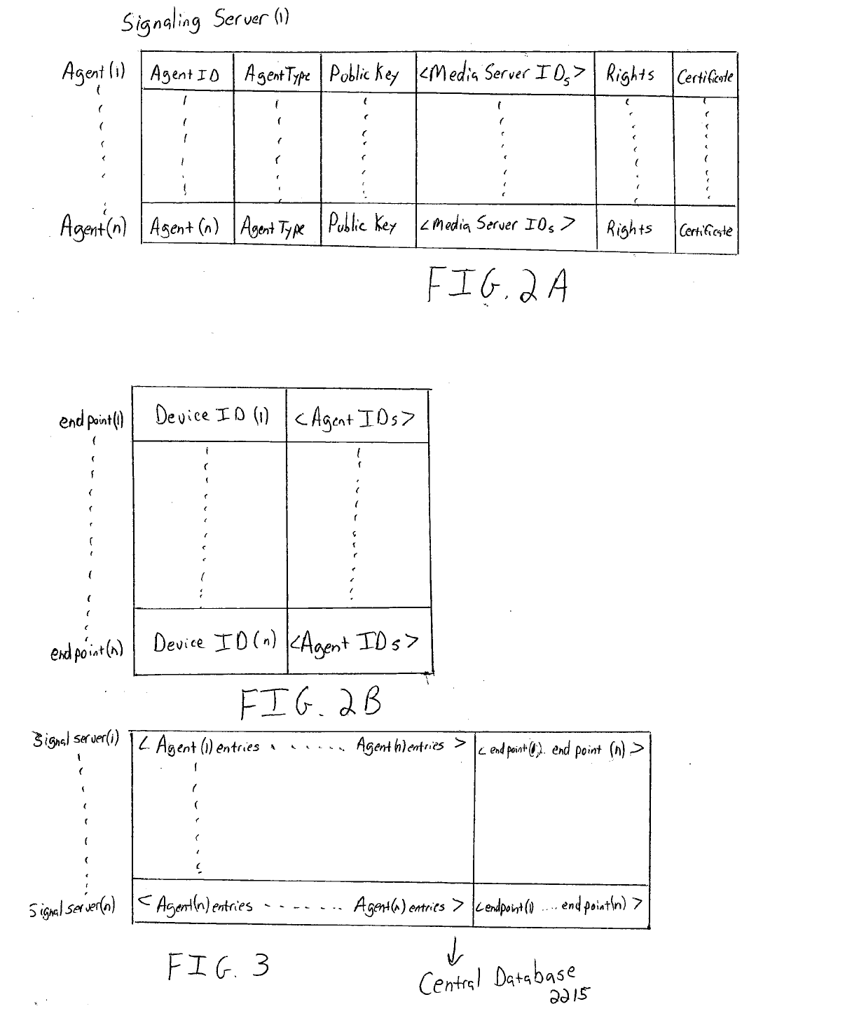

A centralized database 2215 stores a copy of all of the information stored in the agent rights database and the end point database for each signaling server. FIG. 3 illustrates the contents of the centralized database. In the event a signaling server 122 is unable to access its database information locally, the information can be retrieved from the centralized database.

The architecture shown in FIG. 1 allows an authorized agent to lawfully intercept data between end points using a lawful intercept unit (LI). Each agent has an associated LI interfaced with a media server 124 and the LI associated with the authorized agent intercepts data on behalf of the agent consistent with the agent rights of the agent.

An authorized agent is an agent 130 that is granted permission to intercept data consistent with the agent rights of the corresponding agent. For example, agent 130(1) may have agent rights to access recorded call data and full voice communication in real time. In this instance, the LI associated with agent 130(1) will intercept recorded call data and real time full voice communication data.

In order to effectively intercept data from an end point 110, the system must know the travel path of the data. Each end point communicates with a corresponding signaling server 122 when requesting to communicate with another end point. Each signaling server is coupled to one or more media servers and each media server is connected to one or more LI 131. The LI associated with an authorized agent is interfaced with a media server 124. Therefore, the signaling server must route the data from an end point to a corresponding media server interfaced with the LI associated with the authorized agent for intercepting data there from.

Each end point 110 on a call sends the traffic to each other through the media server 124 that the signaling server 122 identified. In an exemplary embodiment, the signaling server 122 tells each end point to contact the same media server. In another exemplary embodiment, the signaling server tells each end point to contact different media servers (e.g., 124(1) and 124(n)). It possible for the media server 124 to route the call traffic between media server 124(1) and 124(n) through zero or more other media servers 124.

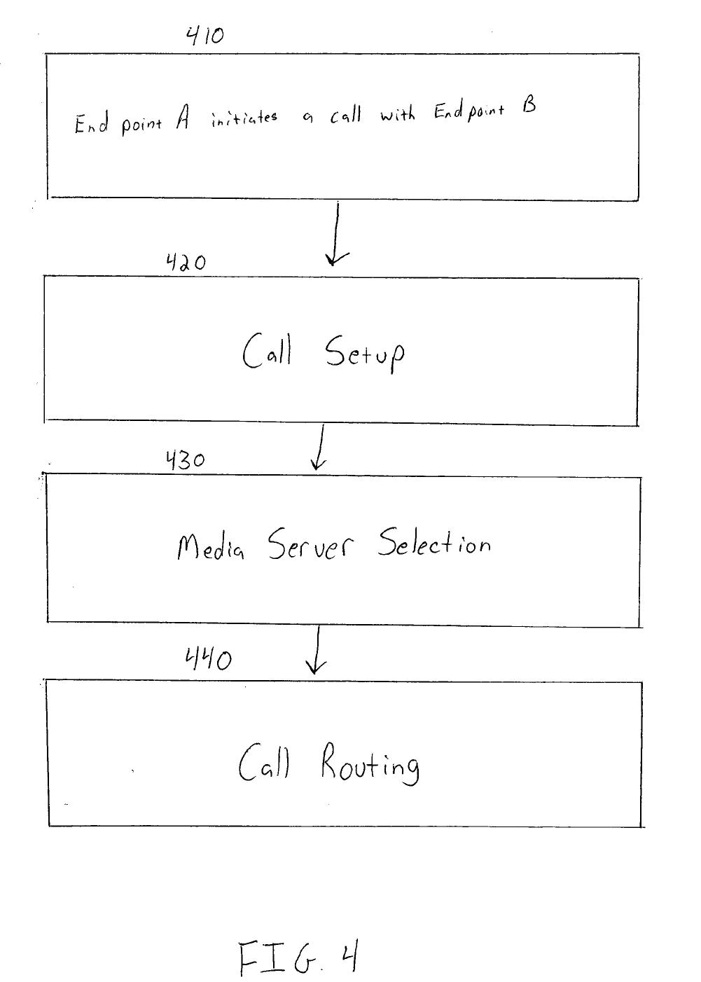

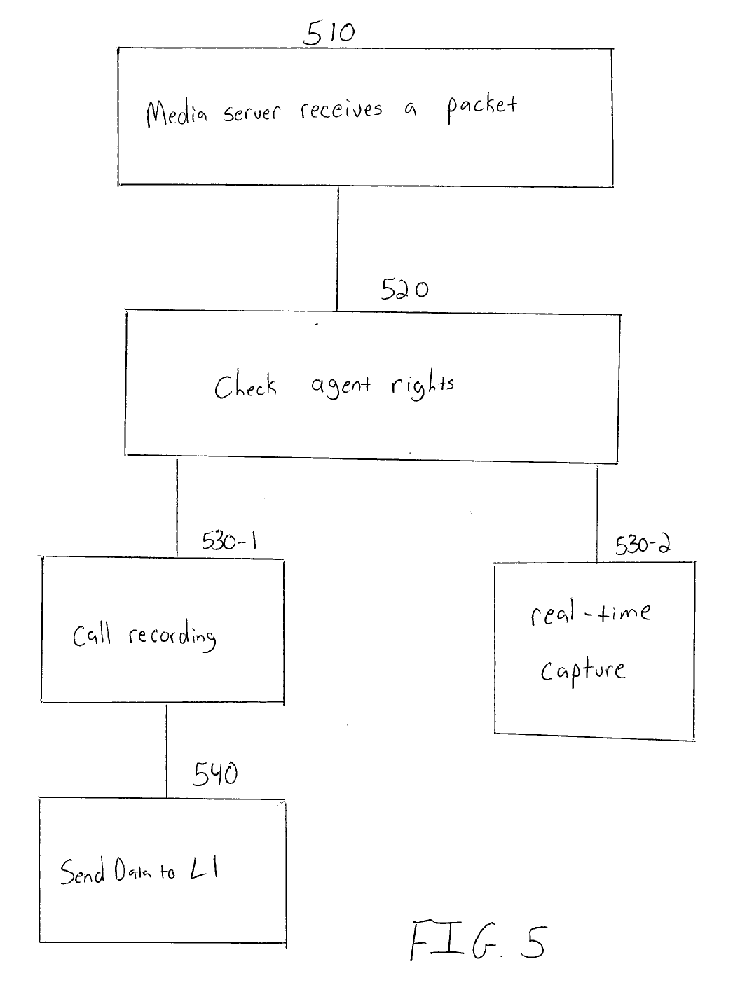

The signaling server sets up and routes data between end points as illustrated in FIG. 4. At step 410, end point A (e.g., end point 110(1)) initiates a call with end point B (e.g., end point 110(2)) by sending a request to the signaling server (e.g., 122(1)) end point A is provisioned to communicate with.

At step 420, the signaling server (e.g., 122(1)) initiates a call setup process by accessing its local end point database to retrieve the end point record(s) associated with the end points on the call and extracting all associated agent IDs (A′). The signaling server accesses its local agent rights database and for each extracted agent ID, the signaling server finds the corresponding agent record in the agent rights database and extracts all the associated media server IDs into a list (K′) containing {media server ID <n>, agent ID <n>}.

At step 430, the signaling server (e.g., 122 (1)) selects one or more media servers to route the data. The signaling server selects an optimal set (S′) of media servers based on the end points A and B of the call, as described in co-pending application, “A Network of Media Servers and a Method of Dynamically Routing Calls Over the Network of Media Servers”, U.S. Application No. 61/382,286, filed on Sep. 13, 2010, incorporated by reference herein, and PCT/US2012/023654 filed on Feb. 2, 2012 incorporated by reference herein.

The signaling server selects a start media server (MSstart) 124, in the selected optimal set (S′), that occurs most often in the list (K′) derived in step 420. If none exists, the signaling server selects the media server that occurs most often in the list (K′). When an agent does not have lawful intercept capabilities from the start media server, prune the list (K′) to contain only those entries by removing from K′ all records that contain the start media server, or the agent ID associated with the start media server. Thereafter, order the records in K′ so that the media server with most agent IDs is first, etc. Then traverse K′ from the right until all agent IDs in K′ have appeared in at least one record and truncate the following records.

Assemble the remaining media servers 124 in the list (K′) into an ordered set (D′) of minimal size, such that all associated agents have lawful intercept access, and add the start media server (MSstart) to the start of the list (D′). The result is a media server path (MSpath) which contains the media server IDs of each media server, for example, MSpath={start media server ID, media server ID 1 . . . end media server ID n}, ordered from left to right.

The address of the start media server (MSstart) is sent to end point A and the call and the end media servers is sent to the other end point (i.e., end point B) using process based on geographic nearness, as described in co-pending application, “A Network of Media Servers and a Method of Dynamically Routing Calls Over the Network of Media Servers”, U.S. Application No. 61/382,286, filed on Sep. 13, 2010, incorporated by reference herein, and PCT/US2012/023654 filed on Feb. 2, 2012 incorporated by reference herein.

A copy of the media server path (MSpath) is sent to each media server in the media server path or an ordered list in the direction of the call flow is sent to each end point. When a media server 124 receives a media server path (MSpath) associated with a call, it adds the end points on the call to the appropriate ends of the list, and stores the result in a local database associated with the call.

At step 440, the call/traffic is routed through the media server path. End point A sends its data to the start media server (MSstart). When a media server receives a network packet associated with a call, it routes the packet to the next node in the media server path associated with the call.

Each LI 131 is able to provide call recordings and/or real time intercepted call traffic to an authorized agent. Call recording data is stored by a corresponding signaling server 122. When the signaling server completes the call setup and routing, it records a call record to a local call record database. The call record includes, for example, caller identifier, caller DeviceID, caller identifier, caller DeviceID, time at which the call started and duration of the call.

In an exemplary embodiment, the call records are stored securely in a local secure database (local to the signaling server) that can only be accessed by suitably authorized people and/or processes.

In another exemplary embodiment, the signaling server 122 optionally has an asymmetric key pair, comprising a public key and private key, and corresponding digital certificate signed by a certificate authority to provide integrity of origin.

Periodically, a call record process within the signaling server 122 extracts and sends call records to associated agents as follows:

1. For each agent record in the agent rights database
a. Extract the rights associated with agent (n) from the database.
b. If agent (n) has the right to receive call records, extract the public key associated with Agent ID(n) from the database; and otherwise end process;
c. Extract all call records associated with a DeviceID that references Agent ID (n) from the database;
d. Extract all call records for Agent ID using the public key from the agent record, so that only agent (n) can decrypt that data, to give encrypted call records.
f. Optionally, add a call record signature, by signing the encrypted call records with the signaling server 122 private key to demonstrate integrity of origin.
g. Send the encrypted call records, optionally with the corresponding call record signature to an agency associated with the Agent ID (n).

When an agent 130 receives this data, the agency associated with the agent, verifies the signature using the signaling server's public key certificate if the data contains a call record signature and exits with an error if the verification fails. The agent decrypts the encrypted call records using the private key, thereby accessing the call records.

FIG. 5 illustrates an exemplary representation of the lawful interception of data. At step 510, media server 124 receives a packet (e.g., encrypted call data either directly or indirectly via another media server) from an end point (e.g., end point A) that is associated with a call to another end point (e.g., end point B). At step 520, the media server checks the end point record in the end point database in the signaling server 122 of the end points associated with the call. The media server checks the agent rights of the Agent IDs associated with the end points.

In another exemplary embodiment, an agent's permission to intercept data is also based on the agent's type and the media server checks the agent type to determine further restrictions upon a corresponding agent for intercepting data.

The media server records the call by duplicating the received packet (RP′) to produce duplicate packet (DP′). The duplicate packet is sent along the path toward end point B and the media server sends the received packet (RP′) to a recorder.

For all agents with LIs 131 associated with the media server, and are granted permission to intercept call recordings, the media server collates the recorded data for each data to provide the call recording to the agent's corresponding LI, at step 530-1.

In an exemplary embodiment, the data is sent to the LI from signaling server 122.

In another exemplary embodiment, the data could be signed to show integrity of origin, for example, by the signaling server 122, using a private key or an equivalent key associated with the originating media server 124.

For all agents with LIs 131 associated with the media server, and are granted permission to intercept real time call data, the media server duplicates the received packet (RP′) to produce duplicate packet (DP′). The media server sends the duplicate packet (DP′) along the path towards end point B and sends the received packet (RP′) to all of the LIs associated with agents authorized to intercept real time call data, at step 530-2.

At step 540, the call recording data is sent to all of the LIs associated with agents authorized to receive call recordings.

The call recordings or real time data may be encrypted data, which requires decryption. The call data may be decrypted using asymmetric key escrow. When an end point (e.g., 110(1)) is provisioned, the agent 130 generates a public key pair comprising a public key (Pbk) and a private key (Pvk) that is associated with an end point (e.g., 110(1)) in a secure management system. The agent 130 stores the key pair in a key database as a record, as follows: DeviceID <n>, public key (Pbk) <n>, private key (Pvk) <n>. The agent provisions the end point with the public and private key. The key database is located locally at the agent, or in a separate key management system that is trusted by the agent, and that can be accessed by the media server associated with the agent.

The agent delivers the key pair, (comprising a public key and private key) to end point 110(1)) using a secure protocol, such as, for example, nCipher's micro HSM protocol.

In an exemplary embodiment, the secure key management system is controlled by the agent 130 or it may be independent of the agent.

When an end point takes part in a call, it generates a session key for an encrypted call, for example, using a protocol described in co-pending application, “A Method of Providing Real-Time Secure Communications Between End Points in a Network, U.S. Application No. 61/408,828, filed on Nov. 1, 2010, incorporated by reference herein, and PCT/US2012/023654 filed on Feb. 2, 2012 incorporated by reference herein. The end point 110 communicates through at least one media server.

Before allowing a call to transmit any data, media server 124 requests the private key corresponding to end point 110(1) from the secure key management system.

The key management system encrypts the key under the agent's public key and sends it to the media server 124. The media server sends the encrypted key to the lawful intercept unit (LI). The media server sends all packets to authorized lawful interception. With knowledge of the key, a LI 131 can deduce the session key from the key exchange protocol. If the media server 124 does not receive the encrypted private key material, it does not forward any media packets and terminates the call.

In another exemplary embodiment, the encrypted data may be decrypted using session key communication. When a lawful intercept unit (LI) is setup, it generates a public key pair comprising a public key (Pbk) and a private key (Pvk), and it creates a digital certificate, such as, for example, an x509 certificate, for the public key signed by a certificate authority. The LI publishes the certificate so that it can be accessed by all end points.

When an end point (e.g., end point 110(1)) takes part in a call, it generates a session key for an encrypted call. Before end point 110(1) starts to transmit encrypted voice data, the end point encrypts session key in with the public key obtained from the certificate to generate an encrypted session key. The end point sends the encrypted session key to the media server 124 before sending and encrypting media traffic.

The media server 124 sends all packets to authorized lawful interception units (LIs), including the encrypted session key. The media server 124 only allows the call traffic to proceed when it has received the packets that contain the session key information. Thus, no encrypted voice can pass until the LI unit has the capability of intercepting the voice traffic.

Thereafter, the LI decrypts the encrypted session key using its private key and stores the session key in a database associated with the call. If the media server does not receive the private key material, it stops forwarding media packets and terminates the call. The media server can distinguish encrypted call traffic from key exchange and other traffic.

As disclosed herein, embodiments and features of the invention can be implemented through computer hardware and/or software. Such embodiments can be implemented in various environments, such as networked and computing-based environments. The present invention is not limited to such examples, and embodiments of the invention can be implemented with other platforms and in other environments.

Moreover, while illustrative embodiments of the invention have been described herein, further embodiments can include equivalent elements, modifications, omissions, combinations (e.g., of aspects across various embodiments) adaptations and/or alterations as would be appreciated by those skilled in the art based on the present disclosure.

What is claimed:

1. A communication system comprising:
one or more end points, wherein each end point is connected to a wireless network;
a media network system comprising:
a registration server for registering device IDs of the end points in the communication system;
a database for storing the device IDs;
one or more media servers for routing calls between end points; and
a signaling server for selecting one or more media servers to route a call between end points in the communication system based on an algorithm that evaluates one or more predetermined conditions.

2. The communication system of claim 1, wherein the end point is a mobile phone.

3. The communication system of claim 1, wherein the end point is a gateway.

4. The communication system of claim 3, wherein the gateway is connected to a Public Switch Telephone Network (PSTN) telephone system.

5. The communication system of claim 3, wherein the gateway is connected to a Private Branch Exchange (PBX) phone system.

6. The communication system of claim 1, wherein said one or more predetermined conditions include the geographic location of the end point relative to the location of a media server.

7. The communication system of claim 1, wherein said one or more predetermined conditions include the loads on each media server in a set of media servers.

8. The communication system of claim 1, wherein said one or more predetermined conditions include the measured quality of service or quality of voice of the media servers.

9. The communication system of claim 1, wherein said one or more predetermined conditions include the availability and status of the media servers.

10. The communication system of claim 1, wherein the signaling server determines whether to use one media server or multiple media servers to route a call based on the geographic location of the end point relative to the available media servers.

11. The communication system of claim 1, wherein the signaling server balances the load between media servers based on the number of calls currently active on each media server.

12. The communication system of claim 1, wherein the signaling server does not provide connection routing information to the one or more media servers.

13. The communication system of claim 1, wherein the signaling server provides a unique session identifier to all nodes of a network participating in a particular connection.

14. The communication system of claim 1, wherein the one or more media servers route traffic received from a network node to all other network nodes participating in a particular connection based on learned routing information.

15. The communication system of claim 14, wherein said one or more media servers learn routing information for all the network nodes participating in the connection from communication traffic received from each network node participating in the connection.

16. The communication system of claim 14, wherein all communication traffic associated with the particular connection include that connection's unique session identifier.

17. A method of dynamically selecting one or more media servers to route a call in a communication system comprising the steps of:
registering, by a registration server, end point information in a database;
receiving a request, at a signaling server, to make a call to an end point in the communication system;
selecting, by the signaling server, one or more media servers to route the call between end points in the communication system based on an algorithm that evaluates one or more predetermined conditions; and
routing the call over a path established by the one or more selected media servers.

18. The method of claim 17, wherein the end point information is a device ID.

19. The method of claim 17, wherein the device ID is created from a random number generator.

20. The method of claim 17, wherein said one or more predetermined conditions include the geographic location of the end point relative to a media server.

21. The method of claim 17, wherein said one or more predetermined conditions include the loads on each media server in a set of media servers.

22. The method of claim 17, wherein said one or more predetermined conditions include the measured quality of service or quality of voice of the media servers.

23. The method of claim 17, wherein said one or more predetermined conditions include availability and status of the media servers.

24. The method of claim 17, wherein the signaling server determines whether to use one media server or multiple media servers to route a call based on the geographic location of the end point relative to the available media servers.

25. The method of claim 17, wherein the signaling server balances the load between media servers based on the number of calls currently active on each media server.

26. The method of claim 17, wherein the signaling server does not provide connection routing information to the one or more media servers.

27. The method of claim 17, wherein the signaling server provides a unique session identifier to all nodes of a network participating in a particular connection.

28. The method of claim 17, wherein the one or more media servers route traffic received from a network node to all other network nodes participating in a particular connection based on learned routing information.

29. The method of claim 28, wherein said one or more media servers learn routing information for all the network nodes participating in the connection from communication traffic received from each network node participating in the connection.

30. The method of claim 28, wherein all communication traffic associated with the particular connection include that connection's unique session identifier.
